(19) United States
(12) Patent Application Publication
(10) Pub. No.: US 2005/0285801 A1
(43) Pub. Date: Dec. 29, 2005

(54) Deployable antennae in a removable card

(76) Inventors: John K. Reece, Colorado Springs, CO (US); Sid J. Reyna, Colorado Springs, CO (US); Clinton R. Ransdell, Colorado Springs, CO (US); Christie M. Bellows, Green Mountain Falls, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/881,604

(22) Filed: Jun. 29, 2004

(51) Int. Cl. H01Q 1/24

(52) U.S. Cl. 343/702; 343/878; 343/880; 455/575.7

(57) ABSTRACT

Removable cards having deployable antennae.

### TECHNICAL FIELD

Embodiments of the invention relate to antennae for use in wireless communications. More particularly, embodiments of the invention relate to removable (e.g., PCMCIA) cards having deployable antennae.

### BACKGROUND

Removable cards, for example, PC cards (previously knows as Personal Computer Memory Card International Association or PCMCIA cards) are common devices that allow a user of a computer system or other electronic device to change system functionality by adding or removing cards that have a specific functionality. PC cards are approximately credit card sized memory or I/O devices that fit into slots in electronic systems that conform to the PCMCIA standards. PC cards are based on standards published by the Personal Computer Memory Card International Association. For example, PCMCIA Standard 2.1 was published in 1993 and defines a 68-pin connector and cards of three sizes or types.

A Type I PC card is 3.3 mm thick and is typically used for memory devices. A Type II PC card is 5.0 mm thick and typically used for modems, network interfaces and audio devices. A Type III PC card is 10.5 mm thick and typically used for Advanced Technology Attachment (ATA) hard drives. Type I and II cards are compatible with a Type III slot and a Type I card is compatible with a Type II slot.

One device that may be implemented as a Type II PC card is a wireless network interface card. For many PC card devices, the outer edge of the PC card is approximately flush with the enclosure of the host device or the outer edge of the PC card extends slightly beyond the enclosure of the host device. However, for wireless network interface cards, in order to provide desired range and signal characteristics the antenna portion of the cards extends beyond the enclosure of the host device. When used in a portable host system that is moved frequently, the antenna portion of these PC cards is exposed to potential damage. This may result in decreased operational life.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 illustrates one embodiment of a removable card and computer system and enclosure configured to operate with the removable card.

FIG. 2 illustrates one embodiment of a removable card having a deployable antenna in a closed position.

FIG. 3 illustrates one embodiment of a removable card having a deployable antenna in an open position.

FIG. 4 is a cutaway view of one embodiment of a removable card having a deployable antenna.

FIG. 5 is a block diagram of one embodiment of an electronic system.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

In one embodiment, a PC card (or other removable component) may include a pop-out antenna. In one embodiment the antenna element may cover the 824 MHz to 960 MHz cellular/GSM bands and/or the 1710 MHz to 1990 MHz DCS/PCS bands. Other and/or different frequency bands may also be supported. In one embodiment the card may be a Type II PC card radio modem with an antenna element that is fabricated on a printed circuit board that may be covered in an overmold (e.g., a rubber overmold) that may provide electrical integrity and/or mechanical flexibility. Other removable cards and other PC card types may also be supported. In one embodiment, the antenna may be housed in a rigid (e.g., plastic) overmold or radome that may provide rigidity and robustness to the RF/mechanical interface.

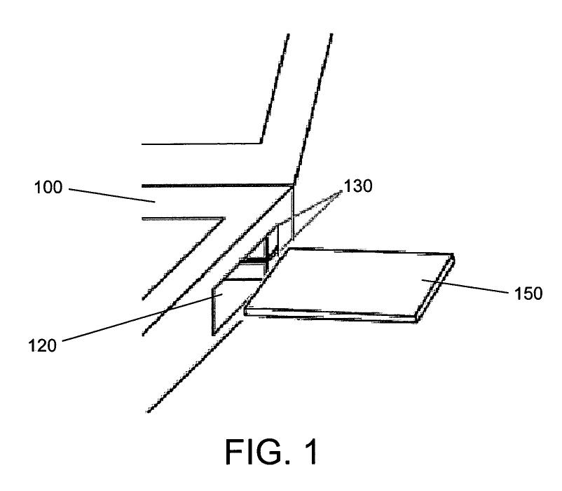

FIG. 1 illustrates one embodiment of a removable card and computer system and enclosure configured to operate with the removable card. Computer system enclosure 100 may house a computer system or other electronic device configured to operate using card 150. The computer system may be, for example, a laptop computer system. Card 150 may be, for example, any type of PC card. In one embodiment, card 150 is a Type II PC card as defined by the PCMCIA specifications cited above. In alternate embodiments, other cards that do not conform to the PCMCIA standards may be used. In one embodiment, card 150 includes at least an antenna (not shown in FIG. 1) that may allow wireless communications using an electronic system.

In one embodiment, card 150 may be inserted into enclosure 100 through slot(s) 120. Using the PCMCIA standards as an example, the dimensions of slot(s) 120 depend on whether slot(s) 120 support Type I, Type II and/or Type III PC cards. When inserted into slot(s) 120, card 150 may connect with an electrical interface within slot(s) 120. Again using the PCMCIA standards as an example, slot(s) 120 may include one or more sets of 68-pin electrical interfaces.

When mated with the electrical interface, card 150 may provide functionality to the electronic system that may not have been available in the absence of card 150. In one embodiment, card 150 may be ejected from slot(s) 120 by a user pressing one of button(s) 130 corresponding to the slot in which card 150 is inserted. PC card interfaces, slots and ejection mechanisms are known in the art.

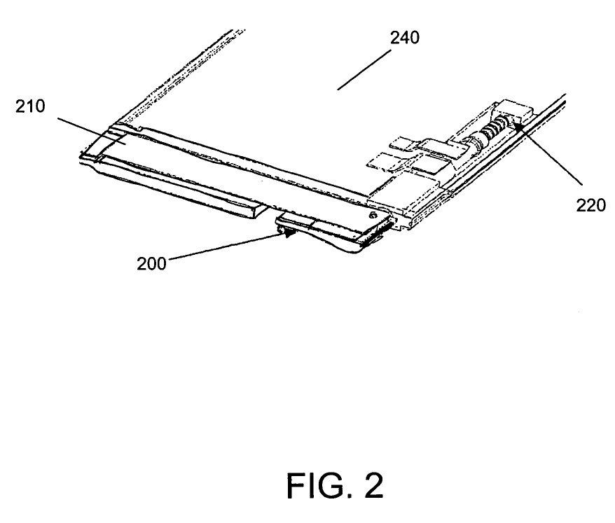

FIG. 2 illustrates one embodiment of a removable card having a deployable antenna in a closed position. In one embodiment, when in the closed position, antenna element 210 may be substantially in the same plane as body 240 (e.g., +/−10° with respect to the plane of body 240, +/−15° with respect to the plane of body 240, +/−20° with respect to the plane of body 240). In one embodiment, antenna element 210 may be maintained in the closed position by clip 200.

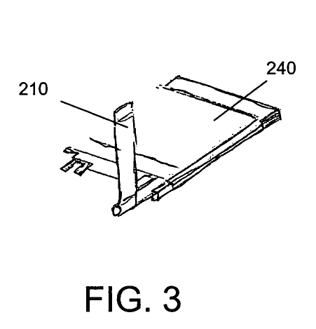

FIG. 3 illustrates one embodiment of a removable card having a deployable antenna in an open position. In one embodiment, when in the open position, antenna element 210 may be substantially perpendicular to body 240 (e.g., +/−10° from perpendicular with respect to the plane of body 240, +/−15° from perpendicular with respect to the plane of body 240, +/−20° from perpendicular with respect to the plane of body 240). In other embodiments, the position of antenna element 240 with respect to body 240 may be different than substantially perpendicular. In one embodiment, the movement of antenna element 210 from the closed position of FIG. 2 to the open position of FIG. 3 may be along a single plane. That is, the axis of rotation of antenna element 210 may be in the plane of body 240.

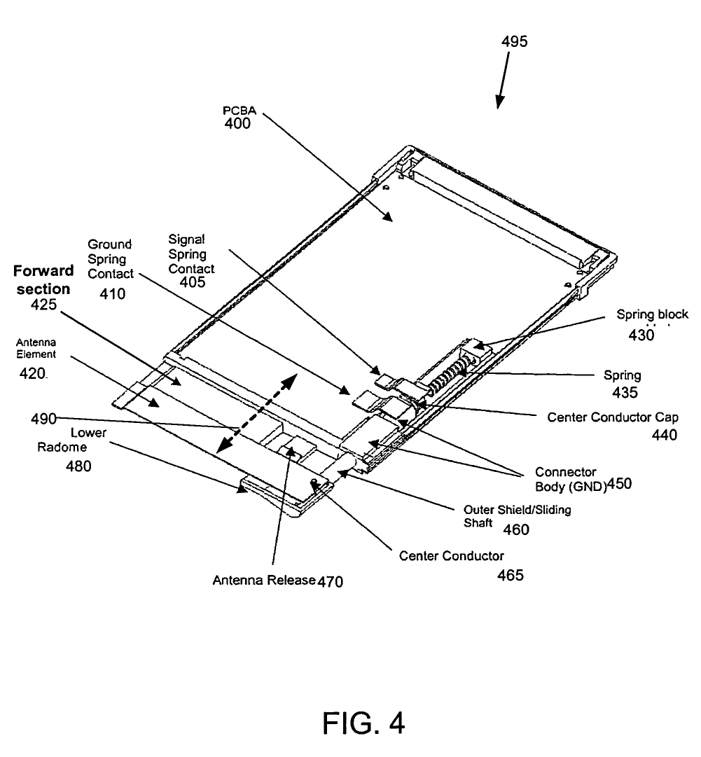

FIG. 4 is a cutaway view of one embodiment of a removable card having a deployable antenna. The card of FIG. 4 is a Type II PC card; however, other removable cards may also be implemented using the deployable antenna described herein. In one embodiment, the length of antenna element 420 may be approximately equal to the width of a body of the card. That is, when antenna element 420 is adjacent to the body of the card, the combined dimensions of the body of the card and antenna element 420 may be approximately equal to a Type II PC card. In one embodiment, antenna element 420 may have a fixed length. In an alternate embodiment, antenna element 420 may be extendable to a length that is greater than the width of the card.

In one embodiment, the antenna and/or radio frequency (RF) connector assembly may move out from a stored position where antenna element 420 may rest upon forward section 425 of removable card 495. That is, in one embodiment, antenna element 420 may extend substantially in the plane of card 495 away from card 495 as well as toward card 495 while substantially in the plane of card 495 (illustrated by dashed line 490). In alternate embodiments, antenna element 420 may be positioned out of the plane of card 495 when moving away from or toward card 495.

In one embodiment, pushing downward on antenna release 470 may allow antenna element 420 to be ejected from the stored position by releasing tension in spring 435. In one embodiment, spring 435 may push on center conductor cap 440 or other component to push antenna element 420 away from the body of card 495. In one embodiment, spring 435 may be attached to, or press against, spring block 430. In one embodiment, spring block 430 may be molded into the frame of card 495. In one embodiment, lower radome 480 may cover a lower portion of antenna element 420. In one embodiment, lower radome 480 may be a rigid material, for example, a plastic or other rigid material that may protect the lower portion of antenna element 420 without excessive detrimental impact on the performance of antenna element 420.

In one embodiment, when antenna element 420 is ejected, connector signal and ground elements of the conductor shaft (housed within outer shield/sliding shaft 460) may align with signal spring contact 405 and ground spring contact 410, respectively. In one embodiment, signal spring contact 405 and ground spring contact 410 may be attached to printed circuit board assembly (PCBA) 400 to pass RF signals. Outer shield/sliding shaft 460 may cover and provide protection for conductive elements housed within.

In one embodiment, when ejected, antenna element 420 is extended beyond card slot overhang and may be rotated to a substantially vertical position to provide improved radiation coverage in the azimuth plane around the host electronic system. An example of an antenna element in the vertical position is provided in FIG. 3. In one embodiment, center conductor 465 may provide a signal path between antenna element 420 and ground spring contact 410. In one embodiment, connector body 450 provides a ground reference.

When a wireless connection is no longer desired, antenna element 420 may be rotated to a substantially horizontal position by being lowered toward forward section 425 and pushed toward PCBA 400. In one embodiment, antenna element 420 may be locked in the horizontal position by pushing antenna element 420 beyond a catch mechanism of antenna release 470.

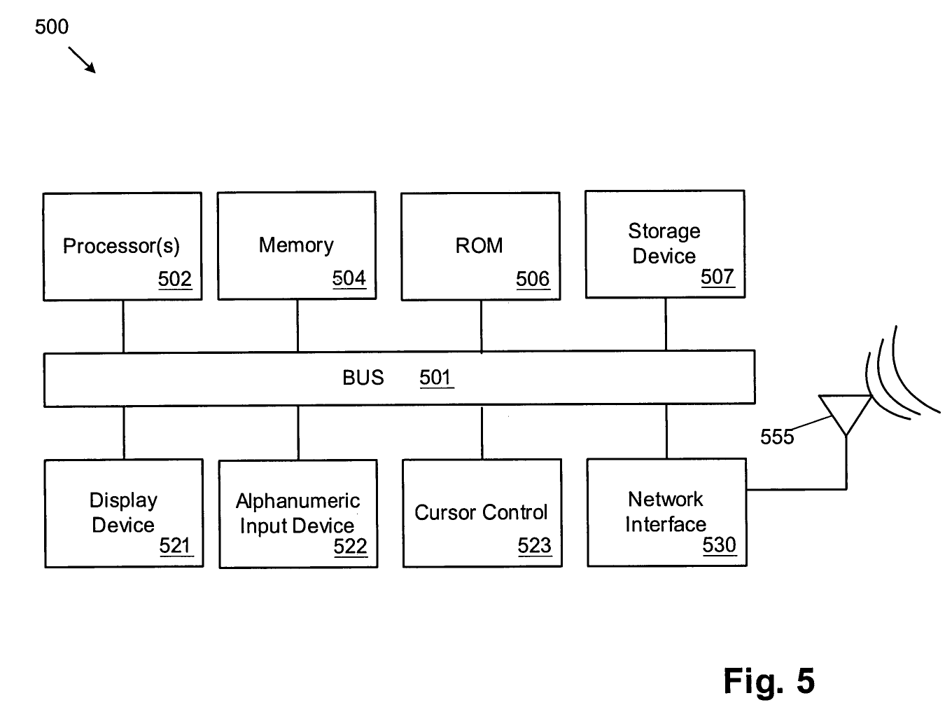

FIG. 5 is a block diagram of one embodiment of an electronic system. The electronic system illustrated in FIG. 5 is intended to represent a range of electronic systems including, for example, desktop computer systems, laptop computer systems, cellular telephones, personal digital assistants (PDAs) including cellular-enabled PDAs, set top boxes. Alternative computer systems can include more, fewer and/or different components.

Electronic system 500 includes bus 501 or other communication device to communicate information, and processor 502 coupled to bus 501 that may process information. While electronic system 500 is illustrated with a single processor, electronic system 500 may include multiple processors and/or co-processors. Electronic system 500 further may include random access memory (RAM) or other dynamic storage device 504 (referred to as main memory), coupled to bus 501 and may store information and instructions that may be executed by processor 502. Main memory 504 may also be used to store temporary variables or other intermediate information during execution of instructions by processor 502.

Electronic system 500 may also include read only memory (ROM) and/or other static storage device 506 coupled to bus 501 that may store static information and instructions for processor 502. Data storage device 507 may be coupled to bus 501 to store information and instructions. Data storage device 507 such as a magnetic disk or optical disc and corresponding drive may be coupled to electronic system 500.

Electronic system 500 may also be coupled via bus 501 to display device 521, such as a cathode ray tube (CRT) or liquid crystal display (LCD), to display information to a user. Alphanumeric input device 522, including alphanumeric and other keys, may be coupled to bus 501 to communicate information and command selections to processor 502. Another type of user input device is cursor control 523, such as a mouse, a trackball, or cursor direction keys to communicate direction information and command selections to processor 502 and to control cursor movement on display 521. Electronic system 500 further may include network interface(s) 530 to provide access to a network, such as a local area network. Network interface(s) 530 may include, for example, a wireless network interface having antenna 555, which may represent one or more antenna(e). Antenna 555 may be a deployable antenna that is part of a removable card as described herein. 22 In one embodiment, network interface(s) 530 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 530 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. An apparatus comprising:
a body enclosing a removable wireless communications component; and
an antenna element connected to the body with a connector that allows the antenna element to move in two planes.

2. The apparatus of claim 1, wherein the antenna element is rotatable along a first axis from a position substantially in plane with the body to a position substantially perpendicular with respect to the body.

3. The apparatus of claim 2 wherein the antenna element is movable substantially in a plane with the body between a first position that is substantially adjacent to the body and a second position that is substantially separated from the body.

4. The apparatus of claim I wherein the body has a length dimension and a width dimension and the antenna element has a fixed length dimension that is approximately equal to the width dimension of the body.

5. The apparatus of claim 1 wherein the body has a length dimension and a width dimension and the antenna element has a length dimension that is variable from approximately equal to the width dimension of the body to greater than the width dimension of the body.

6. The apparatus of claim 1 wherein the body further comprises an antenna latch mechanism to maintain the antenna element in a position substantially in plane with and substantially adjacent to the body.

7. The apparatus of claim 1 wherein the antenna element communicates cellular telephone signals.

8. The apparatus of claim 7 wherein the cellular telephone signals are transmitted in a range of 824 MHz to 960 MHz.

9. The apparatus of claim 7 wherein the cellular telephone signals are transmitted in a range of 1710 MHz to 1990 MHz.

10. The apparatus of claim 1 wherein the antenna element communicates local area network signals.

11. The apparatus of claim 10 wherein the local area network signals conform to IEEE Std. 802.11b and/or IEEE Std. 802.11g.

12. The apparatus of claim 1 wherein when the antenna element is in the first position that is substantially adjacent to the body and in the plane with the body, the body and the antenna element together occupy dimensions that approximately conform to Type II PCMCIA standards.

13. An apparatus comprising:
a body enclosing a removable component having an electrical interface to communicate electrical signals with a host electronic system; and
an antenna element connected to the body with a rotatable connector that allows the antenna element to be rotated with respect to the body and further wherein the rotatable connector allows the antenna element to move between a first position substantially adjacent to the body and a second position substantially separated from the body.

14. The apparatus of claim 13 wherein the electrical interface and the antenna element are connected to opposite ends of the body.

15. The apparatus of claim 13 the antenna element is rotatable from a position substantially in plane with the body to a position substantially perpendicular with respect to the body.

16. The apparatus of claim 13 wherein the body has a length dimension and a width dimension and the antenna element has a fixed length dimension that is approximately equal to the width dimension of the body.

17. The apparatus of claim 13 wherein the body has a length dimension and a width dimension and the antenna element has a length dimension that is variable from approximately equal to the width dimension of the body to greater than the width dimension of the body.

18. The apparatus of claim 13 wherein the body further comprises an antenna release to maintain the antenna element in a position substantially in plane with the body.

19. The apparatus of claim 13 wherein the electrical interface conforms to a Type II PCMCIA card.

20. The apparatus of claim 13 wherein the antenna element communicates cellular telephone signals.

21. The apparatus of claim 20 wherein the cellular telephone signals are transmitted in a range of 824 MHz to 960 MHz.

22. The apparatus of claim 20 wherein the cellular telephone signals are transmitted in a range of 1710 MHz to 1990 MHz.

23. The apparatus of claim 13 wherein the antenna element communicates local area network signals.

24. The apparatus of claim 23 wherein the local area network signals conform to IEEE Std. 802.11b and/or IEEE Std. 802.11g.

25. The apparatus of claim 13 wherein the rotatable connector further allows the antenna element to move substantially in a plane with the body between a first position that is substantially adjacent to the body and a second position that is substantially separated from the body.

26. The apparatus of claim 25 wherein when the antenna element is in the first position that is substantially adjacent to the body and in the plane with the body, the antenna element does not extend beyond an electronic system enclosure within which the body is inserted.

27. The apparatus of claim 25 wherein when the antenna element is in the first position that is substantially adjacent to the body and in the plane with the body, the body and the antenna element together occupy dimensions that approximately conform to Type II PCMCIA standards.

28. The apparatus of claim 25 further comprising a spring to push the antenna element away from the body.

29. A system comprising:
a bus;
a digital signal processor coupled with the bus; and
a removable card coupled with the bus, the removable card having a body including an electrical interface to communicate electrical signals with a host electronic system, and an antenna element connected to the body with a rotatable connector that allows the antenna element to be rotated with respect to the body.

30. The system of claim 29 wherein the electrical interface and the antenna element are connected to opposite ends of the body.

31. The system of claim 29 the antenna element is rotatable from a position substantially in plane with the body to a position substantially perpendicular with respect to the body.

32. The system of claim 29 wherein the body has a length dimension and a width dimension and the antenna element has a length dimension that is approximately equal to the width dimension of the body.

33. The system of claim 29 wherein the body further comprises an antenna release to maintain the antenna element in a position substantially in plane with the body.

34. The system of claim 29 wherein the electrical interface conforms to a Type II PCMCIA card.

35. The system of claim 29 wherein the antenna element communicates cellular telephone signals.

36. The system of claim 35 wherein the cellular telephone signals are transmitted in a range of 824 MHz to 960 MHz.

37. The system of claim 35 wherein the cellular telephone signals are transmitted in a range of 1710 MHz to 1990 MHz.

38. The system of claim 29 wherein the antenna element communicates local area network signals.

39. The system of claim 38 wherein the local area network signals conform to IEEE Std. 802.11b and/or IEEE Std. 802.11g.

40. The system of claim 29 wherein the rotatable connector further allows the antenna element to move substantially in a plane with the body between a first position that is substantially adjacent to the body and a second position that is substantially separated from the body.

41. The system of claim 29 wherein when the antenna element is in the first position that is substantially adjacent to the body and in the plane with the body, the antenna element does not extend beyond an electronic system enclosure within which the body is inserted.

42. The system of claim 29 wherein when the antenna element is in the first position that is substantially adjacent to the body and in the plane with the body, the body and the antenna element together occupy dimensions that approximately conform to Type II PCMCIA standards.

43. The system of claim 29 further comprising a spring to push the antenna element away from the body.

44. An apparatus comprising:
a body enclosing a removable wireless communications component; and
an antenna element connected to the body with a connector that allows the antenna element to move in two planes, wherein the antenna element is rotatable along a first axis from a position substantially in plane with the body to a position substantially perpendicular with respect to the body and further wherein the antenna element is movable substantially in a plane with the body between a first position that is substantially adjacent to the body and a second position that is substantially separated from the body.

45. The apparatus of claim 44 wherein the body further comprises an antenna latch mechanism to maintain the antenna element in a position substantially in plane with and substantially adjacent to the body.

46. The apparatus of claim 44 wherein the antenna element communicates cellular telephone signals.

47. The apparatus of claim 44 wherein the antenna element communicates local area network signals.

48. The apparatus of claim 44 wherein the antenna element communicates personal area network signals.

49. The apparatus of claim 48 wherein the personal area network signals comprise signals that conform to a Bluetooth standard.
